(19) United States
(12) Patent Application Publication
(10) Pub. No.: US 2012/0011963 A1
(43) Pub. Date: Jan. 19, 2012

(54) TRAVERSE MECHANISM

(75) Inventor: Kenneth James Gilbert, Shelby Township, MI (US)

(73) Assignee: Burtek, Inc., Chesterfield, MI (US)

(21) Appl. No.: 12/838,847

(22) Filed: Jul. 19, 2010

(51) Int. Cl. F16H 1/04

(52) U.S. Cl. 74/665 A; 74/405

(57) ABSTRACT

A traverse mechanism for a toothed ring member includes an interface at which modular actuators are attachable to drive a sprocket. The sprocket is selectively movable to a disengaged position wherein the sprocket does not engage the toothed ring member, thereby enabling the use of the traverse mechanism in the event of a malfunction.

### TECHNICAL FIELD

This invention relates to mechanisms for traversing a ring.

### BACKGROUND

Various military vehicles are characterized by a circular hole in the vehicle roof. A ring having teeth on its inner diameter at least partially defines the circular hole. A traverse mechanism is mounted with respect to the ring and includes a toothed member that is engaged with the teeth on the ring. The traverse mechanism supports an automatic firearm and causes the movement of the firearm about the periphery of the ring via rotation of the toothed member.

### SUMMARY

According to a first aspect of the disclosure, an apparatus for traversing a ring having a first plurality of teeth is provided. The apparatus includes a frame, a sprocket, and a drivetrain. The sprocket is rotatably mounted with respect to the frame and has a second plurality of teeth that are meshingly engageable with the first plurality of teeth. The drivetrain has an input member and is configured to transmit torque from the input member to the sprocket. The apparatus further includes a first fastening element that is mounted with respect to the frame and that is selectively, releasably engageable with a first complementary fastening element on a manual crank handle. The apparatus also includes a second fastening element that is mounted with respect to the frame and that is selectively, releasably engageable with a second complementary fastening element on a motor assembly having an output member.

The apparatus is configured such that the manual crank handle and the input member are operatively connected for unitary rotation when the first fastening element is engaged with the first complementary fastening element; and is configured such that the output member is operatively connected to the input member for unitary rotation when the second fastening element is engaged with the second complementary fastening element. Accordingly, a user may select which actuator to employ to apply torque to the input device to drive the apparatus.

According to a second aspect of the disclosure, an apparatus for traversing a ring having a first plurality of teeth includes a frame, a sprocket, and a drivetrain. The sprocket is rotatably mounted with respect to the frame and has a second plurality of teeth that are meshingly engageable with the first plurality of teeth. The drivetrain has an input member and is configured to transmit torque from the input member to the sprocket.

A mounting member is operatively connected to the frame and is configured for operative attachment to the ring. The sprocket is selectively movable with respect to the mounting member between an engaged position in which the second plurality of teeth is engaged with the first plurality of teeth when the mounting member is operatively attached to the ring, and a disengaged position in which the second plurality of teeth is not engaged with the first plurality of teeth when the mounting member is operatively attached to the ring.

Accordingly, the sprocket is selectively disengageable from ring in the event that the drivetrain malfunctions. The mounting member can maintain operative engagement with the ring even when the sprocket is disengaged from the ring, thereby allowing continued use of the apparatus to traverse the perimeter of the ring even if the drivetrain is jammed or otherwise malfunctioning.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, exploded, perspective view of a traverse mechanism having a sprocket, a disengagement lever, and a mounting member in accordance with the claimed invention;

FIG. 2 is a schematic, perspective view of the traverse mechanism of FIG. 1 with two modular actuators that are mountable to the traverse mechanism;

FIG. 3 is a schematic, perspective view of the traverse mechanism of FIG. 1 with an electric motor assembly mounted thereto;

FIG. 4 is a schematic, perspective view of a ring member to which the traverse mechanism is mountable for traversal thereof;

FIG. 5 is a schematic, perspective view of the traverse mechanism of FIG. 1 with the sprocket in an engaged position with respect to the mounting member and the disengagement lever in a first position;

FIG. 6 is a schematic, perspective view of the traverse mechanism of FIG. 1 with the disengagement lever in a second position;

FIG. 7 is a schematic, perspective view of the traverse mechanism of FIG. 1 with the sprocket in a disengaged position with respect to the mounting member and the disengagement lever in the first position;

FIG. 8 is a schematic, bottom view of the traverse mechanism of FIG. 1 with the sprocket engaging the ring member of FIG. 4;

FIG. 9 is a schematic, bottom view of the traverse mechanism of FIG. 1 with the sprocket disengaging the ring member of FIG. 4;

FIG. 10 is a schematic, top, cross-sectional view of an alternative sprocket for use with the traverse mechanism of FIG. 1; and

FIG. 11 is a schematic, side view of the sprocket of FIG. 10.

### DETAILED DESCRIPTION

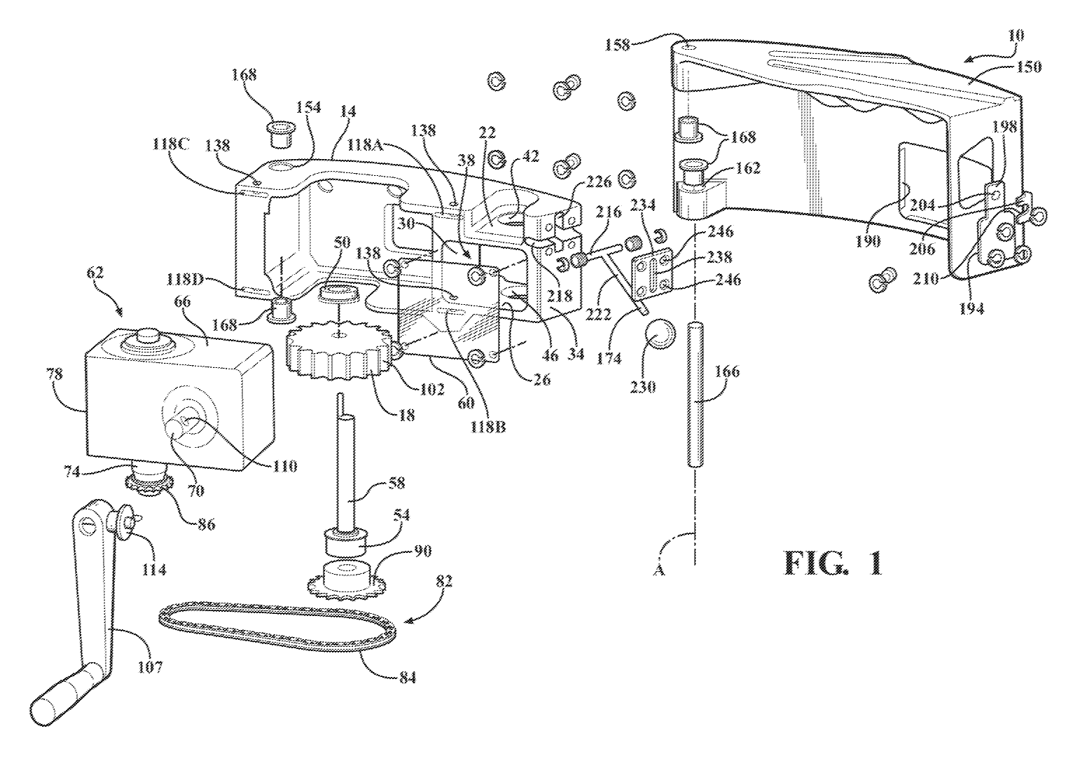

Referring to FIG. 1, a traverse mechanism or apparatus 10 is schematically depicted. The traverse mechanism 10 includes a frame 14. A toothed member, namely sprocket 18, is rotatably mounted with respect to the frame 14. More specifically, the frame 14 includes upper wall 22, lower wall 26, and side walls 30, 34 that cooperate to define a chamber 38. Upper wall 22 defines a cylindrical hole 42 that extends therethrough. Lower wall 26 defines a cylindrical hole 46 that extends therethrough and that is vertically aligned with hole 42. A first bushing 50 is inserted into hole 42 and a second bushing 54 is inserted into hole 46. The bushings 50, 54 support a cylindrical shaft 58 therebetween. The sprocket 18 is mounted to the shaft 58 inside the chamber 38. The shaft 58 and the sprocket 18 are selectively rotatable with respect to the frame 14. A transparent shield 60 is mounted to the frame 14 to cover an opening to the chamber 38.

The apparatus 10 also includes a drivetrain 62 configured to transmit torque to the shaft 58 and the sprocket 18. In the embodiment depicted, the drivetrain 62 includes a gearbox 66 having an input member 70, an output member 74, and gearing (not shown) inside a housing 78. The gearing interconnects the input member 70 and the output member 74 such that torque applied to the input member 70 is transmitted to the output member 74. In the embodiment depicted, the gearing is configured such that the output member 74 rotates about an axis that is generally perpendicular to the axis of rotation of the input member 70. The gearing may also vary the speed ratio between the input member 70 and the output member 74.

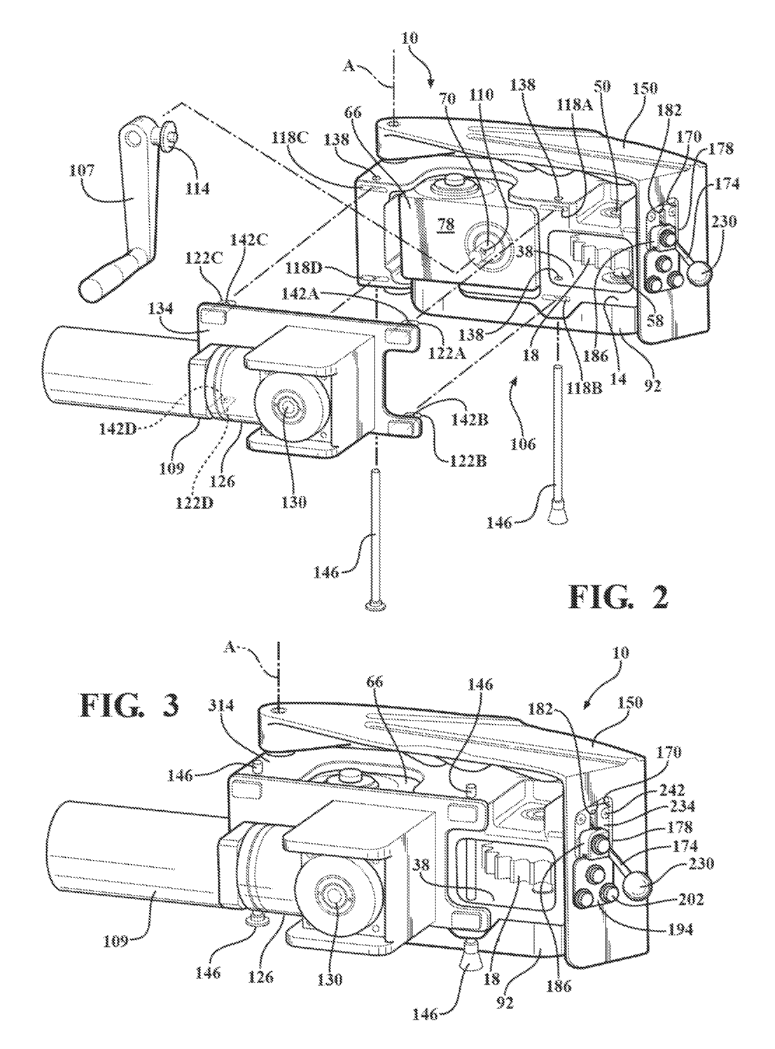

The drivetrain 62 of the embodiment depicted further includes a chain drive mechanism 82 that transmits torque from the output member 74 to the shaft 58. More specifically, the chain drive mechanism 82 includes a chain 84 that engages sprockets 86, 90. Sprocket 86 is mounted to the output member 74 for rotation therewith. Sprocket 90 is mounted to the shaft 58 for rotation therewith. Accordingly, the drivetrain 62 is configured to transmit torque from the input member 70 to the sprocket 18; rotation of the input member 70 causes rotation of the shaft 58 and the sprocket 18. A chain drive cover (shown at 92 in FIG. 2) is mounted to the frame 14. The chain drive cover 92 defines a cavity in which the chain drive mechanism 82 is disposed such that the chain drive mechanism 82 is between the cover 92 and the frame 14.

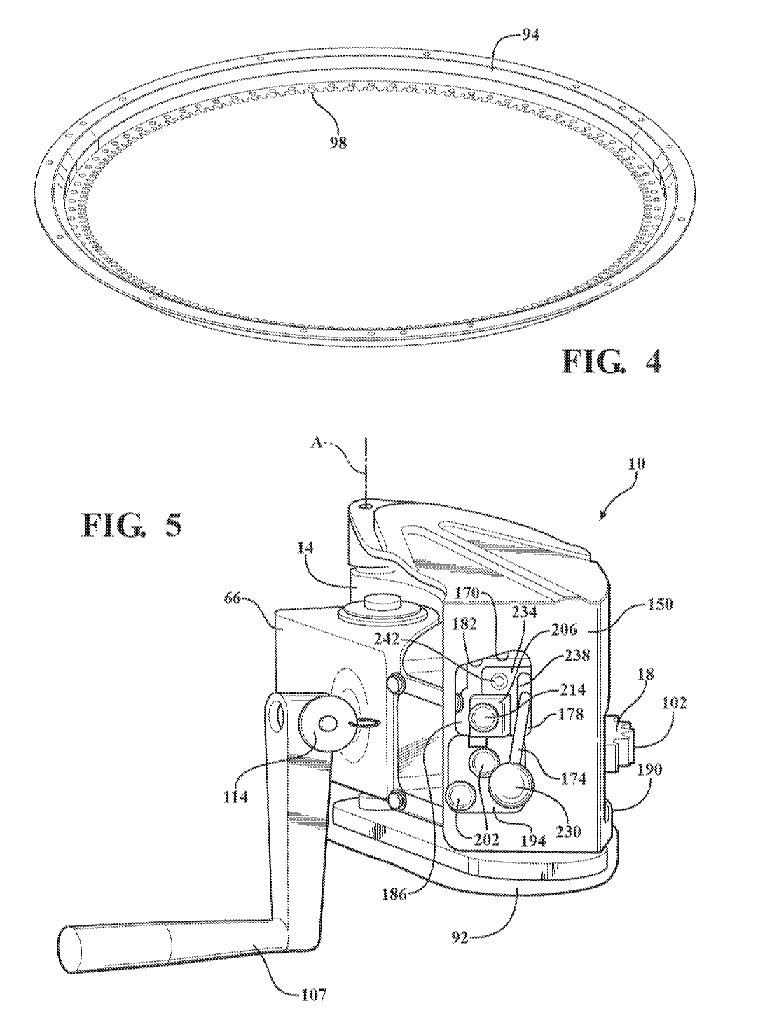

The apparatus 10 is mountable to a ring member (shown at 94 in FIG. 4). Referring to FIG. 4, ring member 94 is characterized by a first plurality of teeth 98 formed on the inner diameter of the ring member 94. The ring member 94 is mountable to the roof of a vehicle (not shown) such that the ring member 94 at least partially defines a circular hole in the roof through which an occupant of the vehicle may extend. Referring again to FIG. 1, the sprocket 18 defines a second plurality of teeth 102 that are meshingly engageable with the first plurality of teeth 98 such that rotation of the sprocket 18 causes the apparatus 10 to traverse the periphery of the ring member 94.

Thus, when the apparatus 10 is operatively connected to the ring member 94, the apparatus is movable along the periphery of the ring member 94 by rotating the input member 70 with respect to the housing 78. Referring to FIG. 2, wherein like reference numbers refer to like components from FIG. 1, the apparatus 10 includes an interface 106 at which at least two differently-configured actuators are fastenable for imparting torque to the input member 70. In the embodiment depicted, the two different actuators are a manual crank handle 107 and a motor assembly 109.

More specifically, the interface 106 includes a first fastening element 110 that is mounted with respect to the frame 14 and that is selectively, releasably engageable with a first complementary fastening element 114 on the manual crank handle 107. The apparatus 10 is configured such that the manual crank handle 107 and the input member 70 are operatively connected for unitary rotation when the first fastening element 110 is engaged with the first complementary fastening element 114. In the embodiment depicted, the first fastening element 110 is a hole formed in the input member 70, and the first complementary fastening element 114 is a pin that is extendable through the hole 110, thereby fastening the crank handle 107 to the input member 70 for unitary rotation.

The interface 106 includes a second fastening element 118A mounted with respect to the frame 14 and that is selectively, releasably engageable with a second complementary fastening element 122A on the electric motor assembly 109. The electric motor assembly 109 includes a motor 126 having a selectively rotatable output member 130. The apparatus 10 is configured such that the output member 130 is operatively connected to the input member 70 for unitary rotation when the second fastening element 118A is engaged with the second complementary fastening element 122A.

In the embodiment depicted, the interface 106 includes a plurality of fastening elements 118A-D that is releasably engageable with complementary fastening elements 122A-D on the motor assembly 109. Fastening elements 118A-D are slots formed in the frame 114. Complementary fastening elements 122A-D are tabs or flat protrusions, extending from a mounting plate 134 to which the motor 126 and output member 130 are connected. Each of the tabs 122A-D is engageable with a respective one of the slots 118A-D, i.e., each of the tabs 122A-D is insertable into a respective one of the slots 118A-D.

The frame defines a plurality of holes 138 that intersect the slots 118A-D. Each of the tabs 122A-D defines a respective hole 142A-D. When the tabs 122A-D are inserted into their respective slots 118A-D, holes 142A-D align with holes 138, such that retention pins 146 are insertable through holes 138 and 142A-D, as shown in FIG. 3, to retain the motor assembly 109 to the frame 14 and to retain the output member 130 in operative connection with the input member 70 for unitary rotation.

The crank handle 107 is removable from the input member 70 by removing the pin 114 from hole 110 and pulling the handle 107 from the input member 70. The motor assembly 109 is removable from the input member 70 by removing the pins 146 and pulling the assembly 109 such that the tabs 122A-D are removed from the slots 118A-D. Accordingly, a user of the apparatus 10 may select which of several actuators to employ to cause the apparatus 10 to traverse the ring 94.

The motor 126 applies torque to the output member 130, which may be the rotor of the motor 126, or which may be connected to the rotor, such as via gearing, to receive torque therefrom. The motor 126 may be electric, hydraulic, etc. within the scope of the claimed invention.

The apparatus 10 further includes a mounting member 150 that is operatively connected to the frame 14. More specifically, and with reference to FIG. 1, the frame 14 in the embodiment depicted defines a hole 154 at one end. The mounting member 150 defines two holes 158, 162. Hole 154 is aligned with holes 158, 162, and a hinge pin 166 extends through hole 154 and into holes 158, 162 such that the mounting member 150 is selectively rotatable with respect to the frame 14 about an axis (shown at A in FIGS. 2-3 and 5-7), which is coextensive with the pin 166. Thus, the sprocket 18, being mounted with respect to the frame 14, is selectively rotatable about axis A with respect to the mounting member 150. The mounting member 150 is configured for attachment to the ring 94. More specifically, the mounting member 150 is movably mounted to the ring 94, such as via bearings (not shown), such that the mounting member 150 is slidable along the periphery of the ring 94. Bushings 168 are employed to mount the pin 166 inside holes 154, 158, 162. The mounting member 150 supports an automatic firearm (not shown).

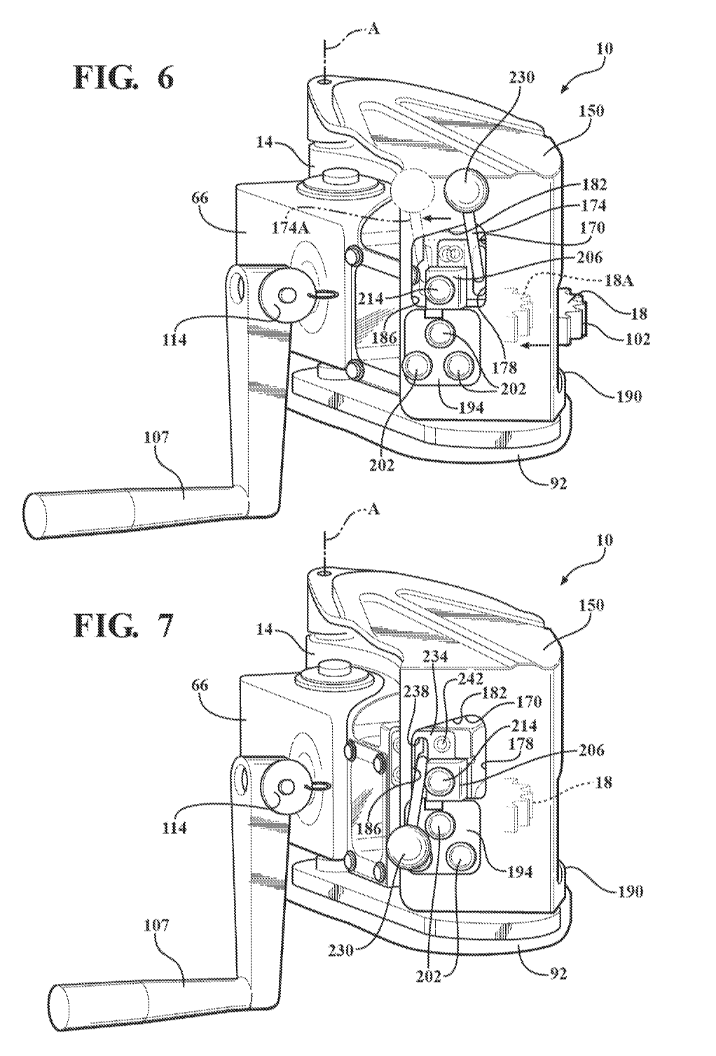

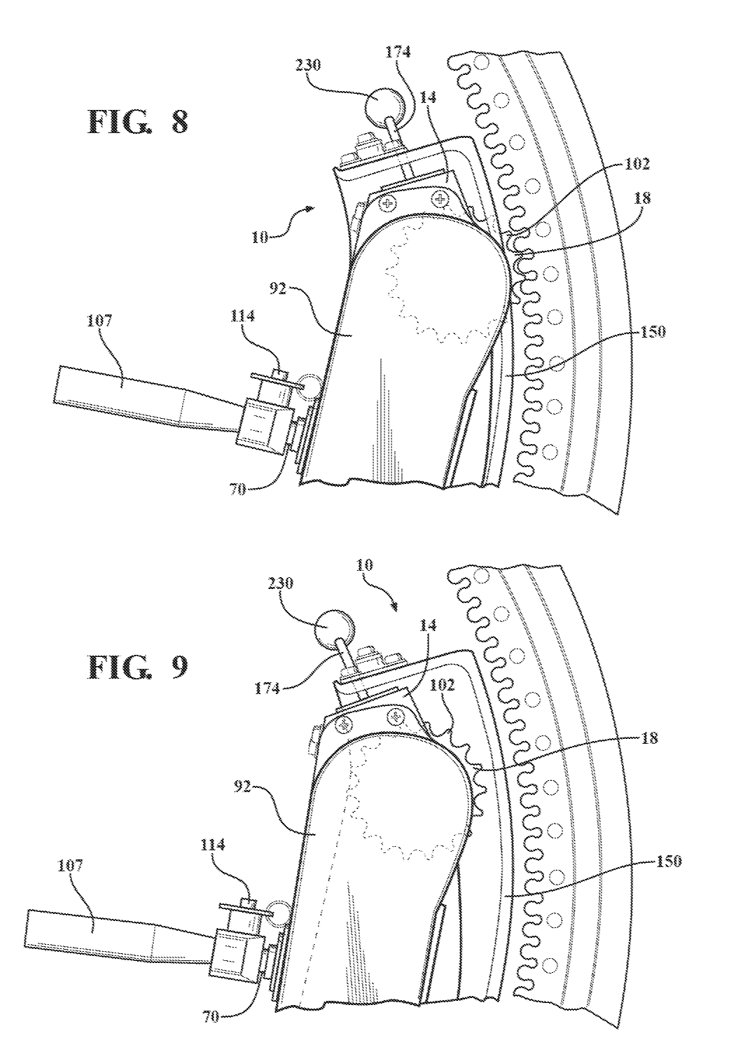

The sprocket 18 is selectively rotatable with respect to the mounting member 150 about axis A between an engaged position, as shown in FIGS. 6 and 8, and a disengaged position, as shown in FIGS. 7 and 9. In the engaged position, the sprocket 18 is positioned such that the second plurality of teeth 102 is meshingly engaged with the first plurality of teeth 98 when the mounting member 150 is operatively connected to the ring 94, as shown in FIG. 8. In the disengaged position, the sprocket 18 is positioned such that the second plurality of teeth 102 is not engaged with the first plurality of teeth 98 when the mounting member 150 is operatively connected to the ring 94, as shown in FIG. 9.

More specifically, the sprocket 18 is rotatable with the frame 14 about axis A with respect to the mounting member 150 between the engaged and disengaged positions. Referring specifically to FIG. 5, the mounting member 150 at least partially defines a C-shaped opening 170. A lever 174 is rotatably mounted with respect to the frame 14 and extends through the C-shaped opening 170. The opening 170 includes a first segment 178, a second segment 182, and a third segment 186. The first and third segments 178, 186 are generally parallel to one another and are generally parallel to the axis A. The second segment 182 is generally perpendicular to the axis A. Thus, when the lever 174 is in the first or third segments 178, 186, physical part interference between the lever 174 and the edges of the opening 170 restrict or prevent rotation of the frame 14 and sprocket 18 with respect to the mounting member 150 about the axis A.

The lever 174 is selectively rotatable with respect to the frame 14 between a first position, as shown in FIGS. 2, 3, 5, and 7, and a second position, as shown in FIG. 6. Referring to FIG. 5, the lever 174 is shown in its first position and extends through the first segment 178 of opening 170. Segment 178 is positioned such that the sprocket 18 is in its engaged position when the lever 174 extends therethrough. When the sprocket 18 is in its engaged position, the sprocket 18 extends through an aperture 190 formed in the mounting member 150 and into engagement with the teeth 98 of the ring 94. The width of segment 178 is such that physical part interference between the lever 174 and the edges of segment 178 prevents the frame 14 and sprocket 18 from rotating about axis A, thereby maintaining meshing engagement between the sprocket 18 and the ring 94.

From the position shown in FIG. 5, the lever 174 is rotatable to its second position with respect to the frame, as shown in FIG. 6. Referring to FIG. 6, the lever 174 extends through segment 182, thereby permitting rotation of the frame 14 and sprocket 18 about axis A such that the lever is in vertical alignment with the third segment 186 (as shown in phantom at 174A) and the sprocket is in its disengaged position (as shown in phantom at 18A). The lever 174 is then rotatable back to its first position, as shown in FIG. 7, with the lever 174 extending through the third segment 186. The width of the third segment 186 is such that physical part interference between the lever 174 and the edges of segment 186 prevents the frame 14 and sprocket 18 from rotating about axis A, thereby maintaining the sprocket 18 out of engagement with the teeth 98 of the ring 94.

During normal operation, the sprocket 18 will be in the engaged position such that the apparatus traverses the ring member 94 as a result of torque applied to the input member 70. However, in the event that there is a malfunction in the drivetrain 62, e.g., if the chain drive mechanism 82 is jammed or the gearbox 66 breaks, the sprocket 18 is movable to the disengaged position so that the apparatus 10 can traverse the ring member 94, such as by a manually applied force to the mounting member 150 or the firearm mounted thereon, without interference from the sprocket 18.

The lever 174 in the embodiment depicted is spring biased in its first position. The width of the first segment 178 is selectively adjustable. More specifically, and with reference to FIGS. 1 and 7, a plate 194 having a protuberant tab 198 is attached to the mounting member 150 via a plurality of fasteners 202 such that the protuberant tab 198 partially forms the C-shaped opening 170, and, more specifically, extends between the first and third segments 178, 186. The tab 198 defines a hole 204. An adjustment member 206 defines an extended slot 210. The member 206 is mounted to the tab 198 with a threaded fastener 214 that extends through the slot 210 and the hole 204. The member 206 defines one edge of the first segment 178, and is selectively movable with respect to the tab 198 such that the width of the first segment 178 is selectively variable. That is, the slot 210 enables the adjustability of the member 206 with respect to the tab 198 and the mounting member 150 to vary the width of the first segment 178 of the C-shaped opening 170, thereby ensuring that the sprocket 18 remains in engagement with the teeth 98 of the ring 94 when the lever 174 is in the first segment 178.

Referring specifically to FIG. 1, the lever 174 includes a first portion 216 that is coextensive with the axis of rotation of the lever 174, and that is at least partially contained within a concavity 218 formed in the frame 14. The second portion 222 of the lever 174 is generally perpendicular to the first portion 214 and extends through the opening 170. The frame 14 defines a concavity 226 that intersects concavity 218, and that accommodates the second portion 222 when the lever 174 is in its first and second positions. A generally spherical knob 230 is mounted to one end of the second portion 222. A plate 234 is mounted to the frame 14 to fasten the lever 174 thereto. The plate 234 defines a slot 238 through which the second portion 222 of the lever 174 extends. Threaded fasteners 242 extend through holes 246 in the plate 234 to mount the plate 234 to the frame 14.

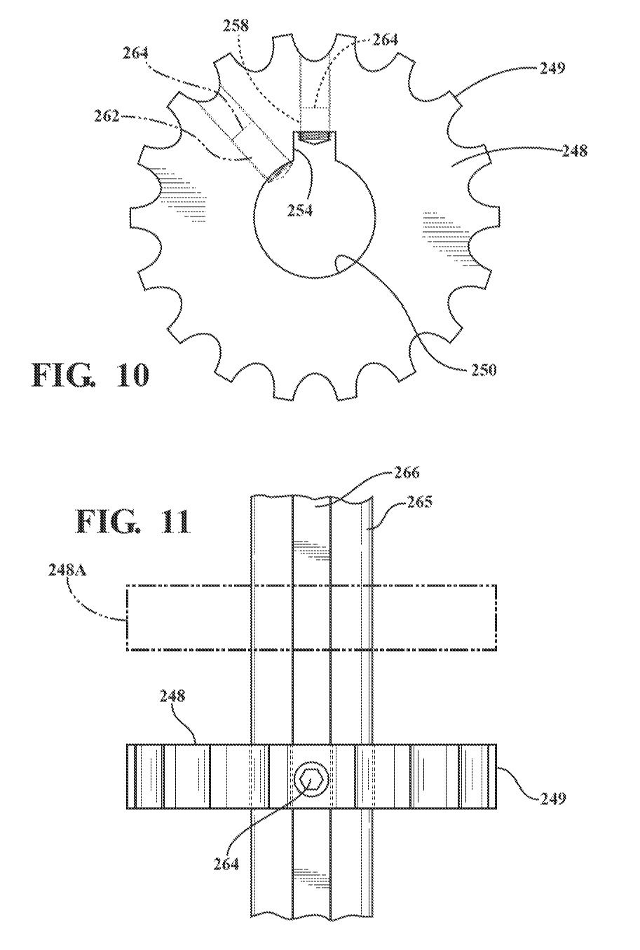

Referring to FIG. 10, an alternative sprocket 248 is schematically depicted. Sprocket 248 is usable in place of sprocket 18 in FIGS. 1-9. Sprocket 248 includes a plurality of teeth 249 that are meshingly engageable with the first plurality of teeth shown at 98 on the ring member 94. Instead of a circular hole in the center, as shown in sprocket 18 (see FIG. 1), sprocket 248 defines a hole 250 having a rectangular keyway 254. The sprocket 248 also defines a threaded hole 258 that extends from between two of the teeth 249 to the distal edge of the keyway 254. Another threaded hole 262 extends from between two of the teeth 249 to the circular portion of hole 250. Each threaded hole 258, 262 contains a respective set screw 264.

Referring to FIG. 11, wherein like reference numbers refer to like components from FIG. 10, the sprocket 248 is mounted to a shaft 265. Shaft 265 is usable in place of the shaft shown at 58 in FIG. 1. Shaft 265 is generally cylindrical, and includes a rectangular key 266. The shaft 265 extends through the hole 250 of the sprocket 248 such that the key 266 is disposed within the keyway 254. The set screws 264 are manipulable to selectively alter the position of the sprocket 248 along the longitudinal axis of the shaft 265, i.e., the height of the sprocket 248.

More specifically, during operation, the set screws 264 contact the shaft 265 and thereby prevent the sprocket 248 from sliding along the length of the shaft 265. By loosening the screws, the sprocket 248 may slide along the shaft to a different position, such as the one shown in phantom at 248A. Tightening the set screws will maintain the sprocket at the new position shown at 248A. The ability to selectively alter the height of the sprocket 248 facilitates proper alignment of the sprocket 248 for meshing engagement with the teeth 98 of ring member 94.

While the best modes for carrying out the invention have been described in detail, those familiar with the art to which this invention relates will recognize various alternative designs and embodiments for practicing the invention within the scope of the appended claims.

1. An apparatus for traversing a ring having a first plurality of teeth, comprising:
a frame;
a sprocket rotatably mounted with respect to the frame and having a second plurality of teeth that are meshingly engageable with the first plurality of teeth;
a drivetrain having an input member and being configured to transmit torque from the input member to the sprocket;
a first fastening element mounted with respect to the frame and being selectively, releasably engageable with a first complementary fastening element on a manual crank handle; and
a second fastening element mounted with respect to the frame and being selectively, releasably engageable with a second complementary fastening element on an electric motor assembly having an output member;
wherein the apparatus is configured such that the manual crank handle and the input member are operatively connected for unitary rotation when the first fastening element is engaged with the first complementary fastening element; and
wherein the apparatus is configured such that the output member is operatively connected to the input member for unitary rotation when the second fastening element is engaged with the second complementary fastening element.

2. The apparatus of claim 1, wherein the second fastening element is a slot defined by the frame, and wherein the second complementary fastening element is a tab defining a first hole.

3. The apparatus of claim 1, wherein the frame defines a second hole that intersects the slot.

4. The apparatus of claim 1, further comprising a mounting member that is operatively connected to the frame and that is configured for operative attachment to the ring;
wherein the sprocket is selectively movable with respect to the mounting member between an engaged position in which the second plurality of teeth is engaged with the first plurality of teeth when the mounting member is engaged with the ring, and a disengaged position in which the second plurality of teeth is not engaged with the first plurality of teeth when the mounting member is engaged with the ring.

5. The apparatus of claim 4, wherein the mounting member is mounted with respect to the frame such that the frame is selectively rotatable with respect to the mounting member about an axis.

6. The apparatus of claim 5, wherein the mounting member at least partially defines a C-shaped opening; and
wherein the apparatus further comprises a lever that is rotatably mounted with respect to the frame and that extends through the C-shaped opening.

7. The apparatus of claim 6, wherein the C-shaped opening is characterized by a first segment, a second segment that extends generally perpendicularly to the first segment, and a third segment that is generally parallel with the first segment;
wherein the first and third segments are generally parallel with the axis.

8. The apparatus of claim 1, further comprising a shaft operatively connected to the sprocket; and wherein the sprocket is selectively slidable along the shaft.

9. An apparatus for traversing a ring having a first plurality of teeth, comprising:
a frame;
a sprocket rotatably mounted with respect to the frame and having a second plurality of teeth that are meshingly engageable with the first plurality of teeth;
a drivetrain having an input member and being configured to transmit torque from the input member to the sprocket;
a mounting member that is operatively connected to the frame and that is configured for operative attachment to the ring;
wherein the sprocket is selectively movable with respect to the mounting member between an engaged position in which the second plurality of teeth is engaged with the first plurality of teeth when the mounting member is engaged with the ring, and a disengaged position in which the second plurality of teeth is not engaged with the first plurality of teeth when the mounting member is engaged with the ring.

10. The apparatus of claim 9, wherein the mounting member is mounted with respect to the frame such that the frame is selectively rotatable with respect to the mounting member about an axis.

11. The apparatus of claim 10, wherein the mounting member at least partially defines a C-shaped opening; and
wherein the apparatus further comprises a lever that is rotatably mounted with respect to the frame and that extends through the C-shaped opening.
